(19) United States
(12) Patent Application Publication
(10) Pub. No.: US 2002/0163662 A1
(43) Pub. Date: Nov. 7, 2002

(54) Printer with means for automatically reordering consumable media and associated method

(76) Inventors: Jeffrey R. Kaufman, Vernon Hills, IL (US); Gerhard Cless, Northbrook, IL (US); David Orr, Kenosha, WI (US); Abbie Schuette, Algonquin, IL (US); Theodore Bielowicz, Schaumburg, IL (US)

Correspondence Address: TREXLER, BUSHNELL, GIANGIORGI,, BLACKSTONE & MARR, LTD., 105 W. ADAMS ST., CHICAGO, IL, 60603, US

(21) Appl. No.: 10/139,017

(22) Filed: May 1, 2002

Related U.S. Application Data
(63) Continuation-in-part of application No. 09/642,538, filed on Aug. 18, 2000.
(60) Provisional application No. 60/287,761, filed on May 1, 2001.

(51) Int. Cl. B41F 1/00; G06F 15/00

(52) U.S. Cl. 358/1.14; 358/1.15

(57) ABSTRACT

A printer is configured such that it can automatically order labels, tags or the like directly from a label, tag or the like production facility over a TCP/IP connection using such protocols as e-mail, hyper-text-transfer-protocol (i.e., web page), and TCP datagrams, and have the ordered labels, tags or the like delivered directly to the physical location of the printer.

### RELATED APPLICATIONS

This application claims the benefit of U.S. Provisional Application Serial No. 60/287,761, filed May 1, 2001, and is a continuation in-part of U.S. patent application Ser. No. 09/642,538, filed Aug. 18, 2000, both of which are hereby incorporated herein by reference in their entirety.

### BACKGROUND

The present invention relates generally to printers which are configured to print onto consumable media, such as labels, tags or the like, and more specifically relates to a printer which is configured to monitor its own consumption of consumable media and automatically order more consumable media from, for example, an order-fulfillment house or production facility.

It is advantageous to prevent printer downtime, or at least keep downtime to a minimum. Oftentimes, printers which print labels, tags or the like, such as barcode printers, are used in mission-critical applications. In such circumstances, when a printer goes down, it can be quite costly. For example, if a printer configured to print shipping labels runs out of ribbon or labels, it is possible that several hundred boxes will be placed into inventory without identification. In this case, every hour that the system or printer is unavailable can cost hundreds of thousands of dollars or more in lost productivity. Hence, it is advantageous to prevent printer downtime, and in mission-critical applications, it is generally economically imperative.

U.S. patent application Ser. No. 09/642,538, which has been incorporated herein by reference, discloses a printer which provides an active alerting feature. This feature immediately alerts an information technology person or other person responsible for managing the printer that the printer needs servicing, such as a new thermal printhead or additional labels. The alert generated from the printer can be selectively transmitted over a plurality of communication channels to the person responsible for servicing and keeping the printer operating for the purpose of minimizing printer down time which directly correlates to a minimization in lost productivity. The communication channels may include e-mail, cellular or satellite pager, and the printer's display.

FIGS. 1 and 2 of the present application illustrate a printer 10 which is consistent with that which is described in U.S. patent application Ser. No. 09/642,538. The printer 10 is configured to print labels 12, and includes a display 14 which shows various printer alert conditions in textual or graphical format. As shown in FIG. 2, the printer 10 is configured such that it can be connected to a TCP/IP network 16, and the TCP/IP network 16 may contain Internet, Intranet, LAN, and WAN connectivity. When the printer 10 encounters a printing error such as being out of labels, the printer 10 sends an alert message over the TCP/IP network 16. That message may be selectively transmitted and routed over e-mail 18, to a cellular paging system 20, or on to the printer's display 14. A cellular receiving device 22 receives the page. An optional mail-server 24 may be required to handle the transmission of e-mail messages from the printer 10 over the TCP/IP network 16 to successfully transmit e-mail messages 18 containing the printer alert messages.

Typically, a network manager would select what alert messages would be communicated and how the alert messages will be communicated by selecting what communication channel or channels over which the alert messages will be transmitted. For example, a network manager may have a goal of not transmitting alert messages about the printer's power supply temperature to anyone. Hence, the network manager may disable that alert message, i.e., prevent that particular alert message from being communicated. Furthermore, the network manager may desire that alerts regarding whether the printer requires a new thermal printhead be communicated via e-mail 18 to a printer service worker and herself, and, simultaneously inform the printer operator of the printer's alert condition via the printer's front panel display 14. In addition, the network administrator may desire that any alert conditions regarding the state of the printer's label supply be communicated via cellular pager 22 to a second mobile service worker to locate and deliver labels to the location of the printer 10 to minimize printer downtime.

As described in U.S. patent application Ser. No. 09/642,538, one type of alert generated by the printer 10 shown in FIGS. 1 and 2 of the present application may be an alert regarding the state of the printer's label supply. However, the printer 10 is only capable of detecting when the printer 10 is completely out of labels. When the printer 10 is out of labels, the printer 10 immediately stops printing until a new supply of labels is inserted into the printer 10, and transmits an alert message that the printer 10 is out of labels. Depending on how the network manager has configured the printer 10 with regard to alert messages, the printer 10 may alert either the printer operator via the printer's front panel 14 or directly alert a mobile worker using a cellular paging device 22. Although these communication methods are effective in procuring replacement labels for the printer 10, the time period between when the printer 10 transmits the alert message and new labels are delivered to the printer 10 may range from minutes to hours depending on how quickly new labels can be located and delivered to the printer 10. This time period between when the printer 10 stops printing labels and a new label supply is provided to the printer 10 results in downtime and lost productivity, which can be very expensive.

To minimize printer downtime and maximize productivity, replacement label stock is typically stored near the printer 10 unless space constraints prohibit such label storage. Regardless, in order to keep an adequate supply of replacement label stock on hand, the printer operator needs to periodically order additional label stock. This is neither convenient nor productive for the printer operator to do, and oftentimes the printer operator will forget to order replacement labels. In such case, when the printer runs out of labels and stops printing, expensive productivity time is lost while an order for new labels is placed, and the labels are finally received and installed in the printer 10.

In most applications, the printer operator would order replacement labels from her company's stock room by filling out a stock-requisition, which is an ineffective use of the printer operator's time. The company's stock room or purchasing agent is typically responsible for keeping track of the printer's label consumption rate so that a continuous supply of labels may be provided to the printer 10. Unfortunately, oftentimes the company's stock room or purchasing agent may have not ordered replacement labels because neither were informed nor aware of the printer's label consumption rate. When this occurs, substantial printer downtime occurs since labels have to be ordered from an order-fulfillment house or label production facility, which is normally located outside of the company. Delays from days to weeks are not uncommon, which can cause substantial financial hardship upon the company.

### OBJECTS AND SUMMARY

An object of an embodiment of the present invention is to provide a printer which can monitor its own consumption of consumable media, such as labels, tags or the like, and order more consumable media upon its consumption of the consumable media reaching a pre-determined level, thereby eliminating or at least reducing printer downtime.

Another object of an embodiment of the present invention is to provide a method for a printer to automatically order its own consumable media, thereby eliminating or at least reducing printer downtime.

Another object of an embodiment of the present invention is to provide a computer readable medium having stored thereon computer executable instructions which are readable by a printer, where the instructions are configured to direct the printer to measure a quantity of consumable media consumed by the printer and automatically order consumable media.

Another object of an embodiment of the present invention is to provide a method of keeping a printer supplied with consumable media, where the method includes having the printer monitor the quantity of consumable media consumed by the printer and order more consumable media.

Still yet another object of an embodiment of the present invention is to provide a printer which is configured such that it can automatically order consumable media such as labels, tags or the like directly from a label, tag or the like order-fulfillment house or production facility over a TCP/IP connection using such protocols as e-mail or hypertext-transfer-protocol (i.e., web page and HTTP) or FTP, and have the ordered consumable media (e.g., labels, tags or the like) delivered directly to the physical location of the printer.

Another object of an embodiment of the present invention is to provide a printer which can be configured by a printer administrator to automatically order consumable media such as labels, tags or the like directly from a label, tag or the like order-fulfillment house or production facility once a pre-determined quantity of labels, tags or the like has been consumed by the printer.

Briefly, and in accordance with at least one of the foregoing objects, an embodiment of the present invention provides a printer which is configured to print onto consumable media, such as labels, tags or the like, where the printer includes a means for determining the quantity of labels, tags and the like consumed and includes a means for transmitting the printer's label, tag or the like consumption information via e-mail or TCP message to a world-wide-web internet site which collects such information and disseminates that information to a label, tag, or the like order-fulfillment house or production facility.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 is a perspective view of a printer which is configured to generate and transmit alert messages about the printer;

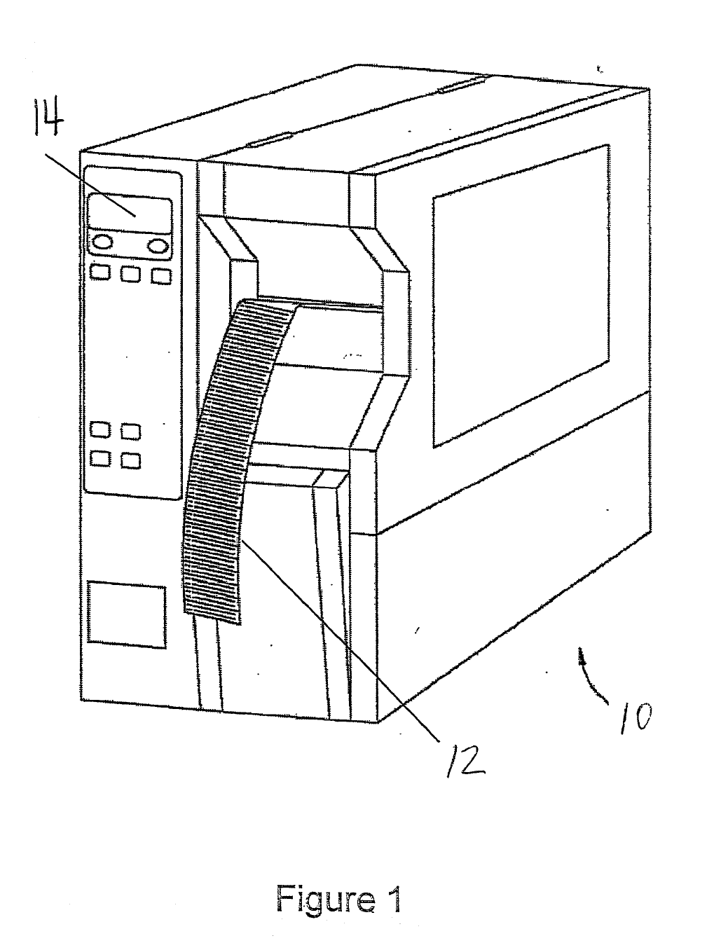

FIG. 2 is a view of the printer illustrated in FIG. 1, showing the printer connected to a TCP/IP network over which the printer transmits the alert messages;

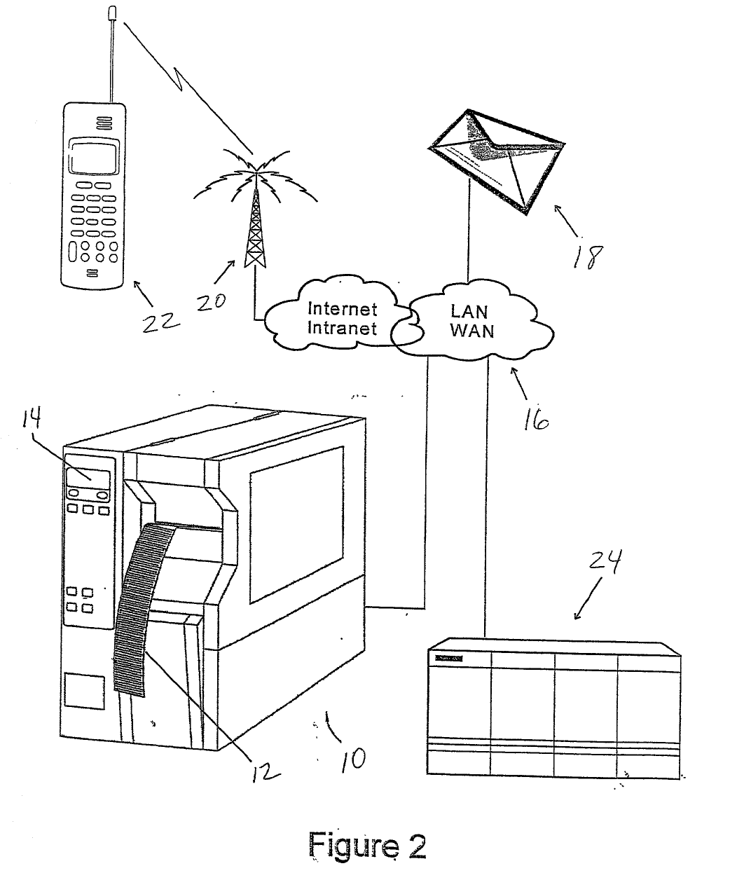

FIG. 3 is a perspective view of a printer which is in accordance with an embodiment of the present invention;

FIG. 4 is a block diagram illustrating certain portions of the printer shown in FIG. 3;

FIG. 5 is a view similar to FIG. 3, but showing the printer in communication with an e-mail server;

FIG. 6 illustrates a web site to which the printer shown in FIGS. 3-5 is configured to send TCP messages;

FIG. 7 illustrates the situation where the printer shown in FIGS. 3-5 is configured to send information directly to an order-fulfillment house or production facility;

FIG. 8 illustrates a first portion of a program which operates the printer shown in FIG. 7; and

FIG. 9 illustrates a second portion of the program shown in FIG. 8.

### DESCRIPTION

While the present invention may be susceptible to embodiment in different forms, there are shown in the drawings, and herein will be described in detail, embodiments of the invention with the understanding that the present description is to be considered an exemplification of the principles of the invention and is not intended to limit the invention to that as illustrated and described herein.

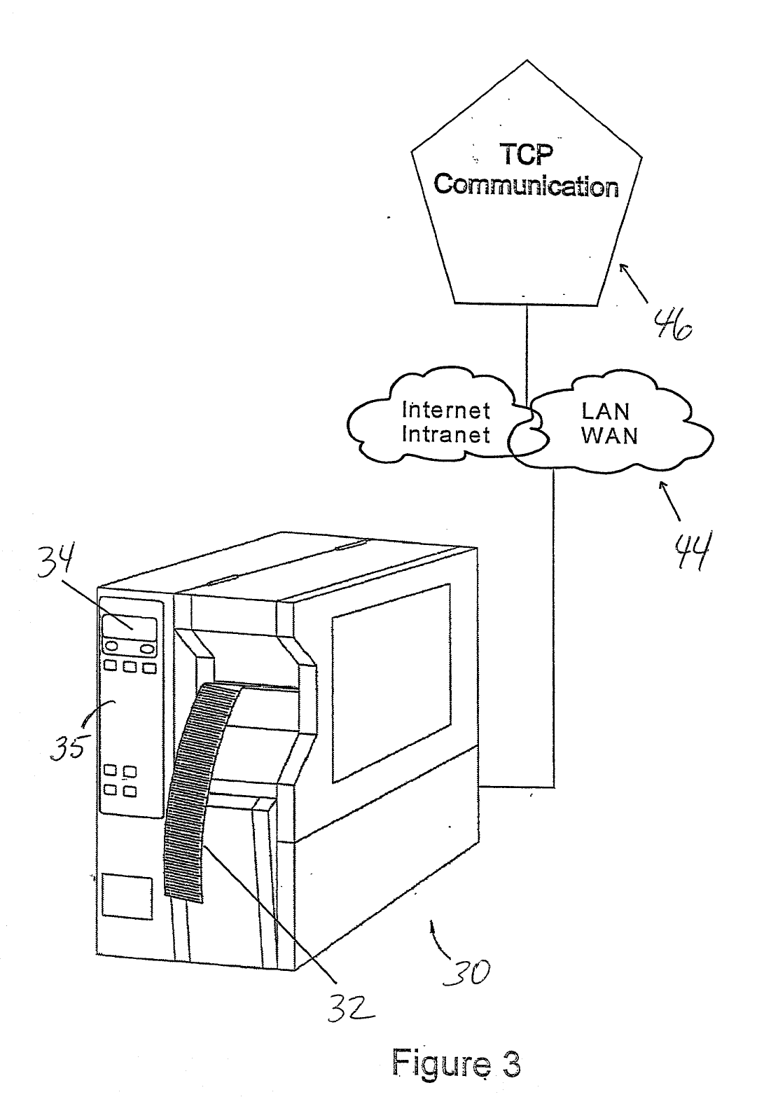

FIGS. 3-5 illustrate a printer 30 which is in accordance with an embodiment of the present invention. Printer 30 is configured to monitor their consumption of consumable media, such as tags, labels or the like, and automatically order more consumable media without human intervention. As a result, the printer 30 is configured to eliminate or at least substantially reduce printer downtime which may otherwise result from the printer 30 running out of consumable media, such as tags, labels or the like.

Printer 30 is configured to print variable indicia onto consumable media, such as label, tag or the like stock 32. Information about the printer's status and various printing configuration settings are preferably displayed in the printer's LCD display 34, and the printer 30 preferably includes an operating panel 35 which provides an interface for operating or otherwise setting parameters relating to function of the printer 30.

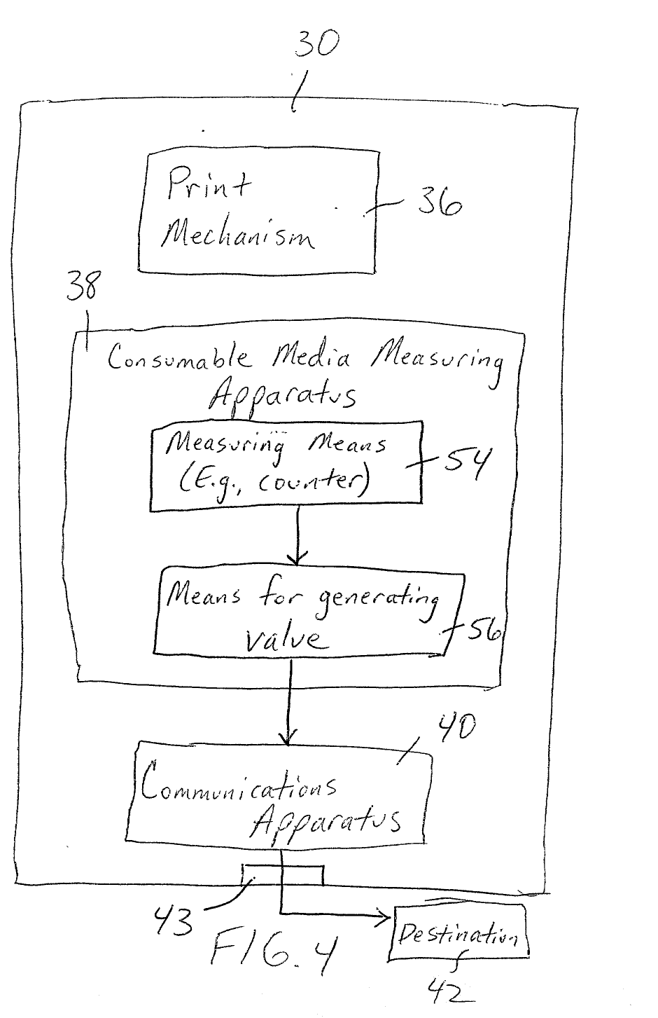

As shown in FIG. 4, the printer 30 preferably includes not only a print mechanism 36 for printing onto consumable media, but also consumable media measuring apparatus 38, and communications apparatus 40 which is coupled to the consumable media measuring apparatus 38. Preferably, the consumable media measuring apparatus 38 is configured to measure a quantity of consumable media consumed by the printer 30, and is configured to communicate consumable media consumption data to the communications apparatus 40. Preferably, the communications apparatus 40 is configured to transmit the consumable media consumption data to a destination 42 which is external to the printer 30, such as to a web site, a consumable media order-fulfillment house, a consumable media production facility, or some other appropriate destination.

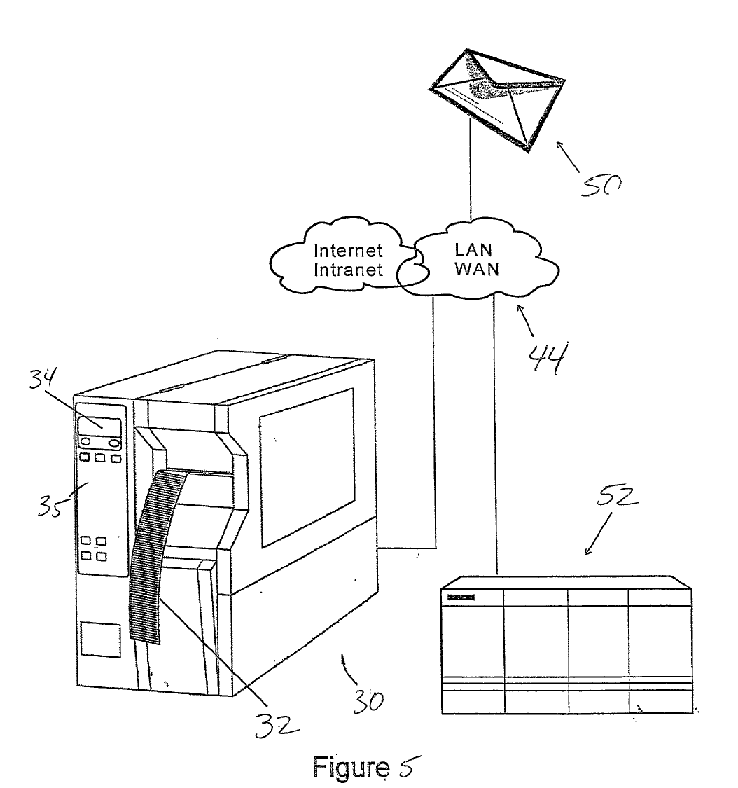

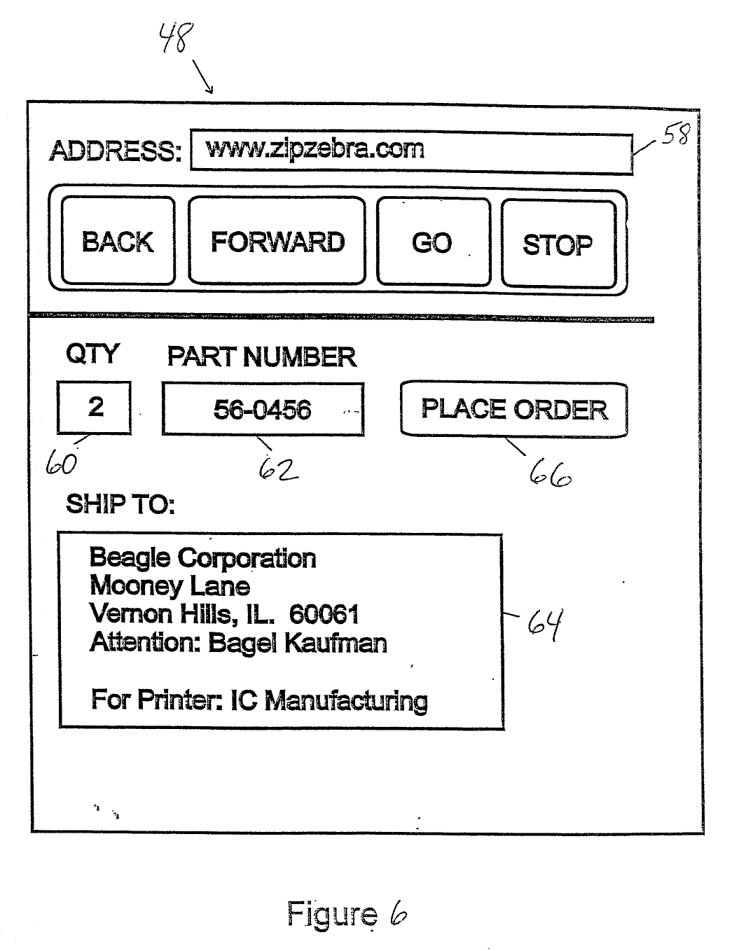

As shown in FIGS. 3 and 5, preferably the printer 30 is configured such that it can be connected to a TCP/IP network 44, such as a LAN, WAN, Internet, or an Intranet network, where bi-directional TCP/IP communions can take place between the network 44 and the printer 30. This connection provides the ability for label formats and data to be transmitted to the printer 30, and status information to be transmitted from printer 30. In addition, printer configuration settings such as darkness may be transmitted to the printer 30 from the network 44 via e-mail, TCP, or UDP. Preferably, the printer 30 is configured such that it can be set to send out a TCP message 46 over the TCP/IP network 44 containing the status of the printer 30, or any other information that printer 30 requires to be transmitted to a destination, such as to a web site 48 as shown in FIG. 6 on the network 44. Optionally, as shown in FIG. 5, the printer 30 can be configured to send status or other information over network 44 via an e-mail message 50. As shown, an e-mail server 52 may be provided to send and route such an e-mail message 50 over the network 44. Furthermore, the printer 30 can be configured such that it can transmit status information over a port 43 of the printer 30, such as the printer's parallel or serial port.

As described above, printer 30 includes a consumable media measuring apparatus 38 which is configured to count the number of consumable media, such as tags, tickets or the like, consumed by the printer 30. The media measuring apparatus 38 may be provided in the form of firmware internal to the printer 30 which determines the number of labels, tags, or the like printed by incrementing an internal counter for every label, tag, or the like printed. Specifically, as shown in FIG. 4, the consumable media measuring apparatus 38 may consist of means 54 for measuring a quantity of consumable media consumed by the printer 30, where the means 54 includes a counter, as well means 56 for generating a consumable media consumption value based on the quantity which is measured. Preferably, the means 56 for generating a consumable media consumption value is in communication with the communications apparatus 40, and is configured to communicate the consumable media consumption value thereto for subsequent transmission to destination 42 external to the printer 30.

Specifically, the printer 30 can be configured such that it can be programmed to send out an e-mail message 50 or TCP message 46 over network 44 when the printer 30 consumes a pre-determined quantity of consumable media, e.g., prints a pre-determined quantity of labels, tags or the like. Preferably, the printer 30 is configured such that the pre-determined quantity of labels, tags or the like printed before an alert message is transmitted over network 44 is variable and modifiable by sending an e-mail message, TCP message, UDP message or FTP transmission to the printer 30, or by communicating with the printer's serial port or parallel port 43, over network 44 or other means. Alternatively, or in addition, the printer 30 can be configured such that such information can be communicated to the printer using the printer's operations panel 35. Furthermore, the printer 30 can be configured such that it can be programmed, as described above, with instructions on the address to send e-mail message 50 or TCP message 46 over network 44. Preferably, the printer 30 is configured such that it can be programmed to send information via a TCP message 46 to a web site 48 using HTTP, FTP, UDP or other similar protocols to order consumable media, such as labels, tags or the like, directly from the web site 48 without human intervention.

In operation, printer 30 is programmed with the quantity of consumable media, such as labels, tags or the like, to be printed before an alert message is transmitted over network 44 via e-mail 50 or a TCP message 46. Preferably, the printer 30 sends a TCP message 46 once the printer 30 has printed a pre-determined, pre-set quantity of labels, tags or the like. Preferably, the destination for that TCP message 46 is a web site 48, as shown in FIG. 6, and the TCP message 46 destination is web address 58. The printer 30 is configured such that the TCP message 46 which is transmitted by the printer 30 fills in the quantity of labels 60, label part number 62 and address information 64. After that information is transmitted to web site 48, printer 30 sends another TCP message to the website 48 which has the effect of depressing button 66, thereby, placing an order for replacement labels.

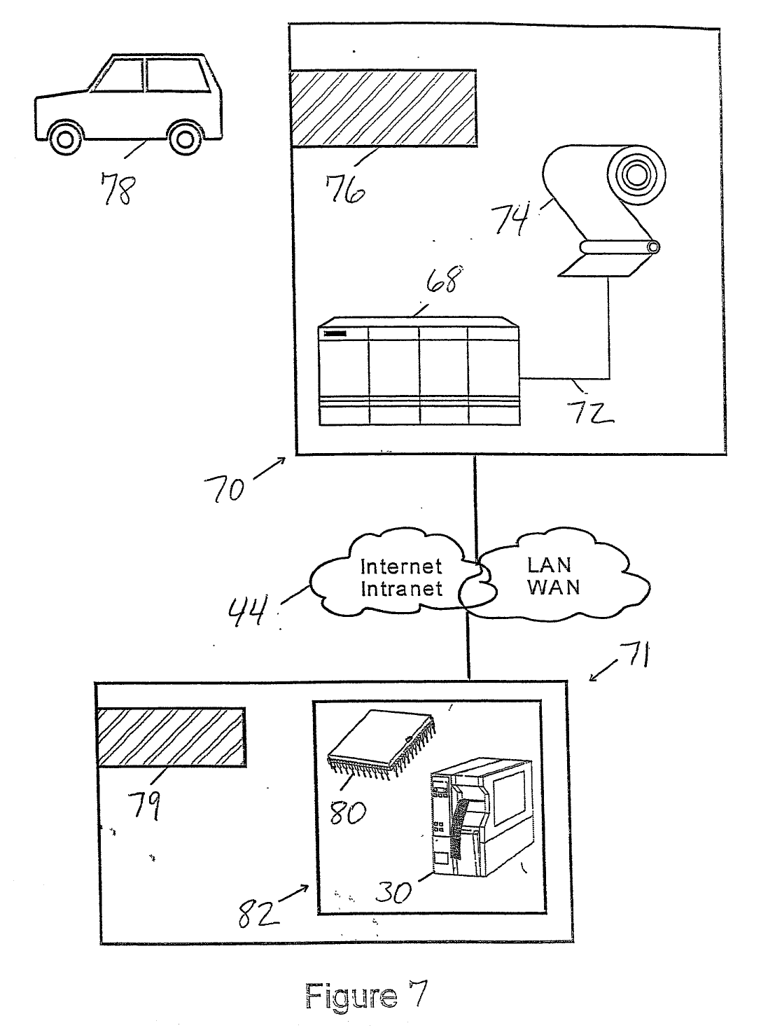

Web site 48 may be hosted on a web server 68, as shown in FIG. 7, which is located in a facility 70 relating to consumable media, such as an order-fulfillment house or a consumable media production facility. FIG. 7 specifically depicts the case where the printer 30 is located in a manufacturing plant 71, and communicates directly with a consumable media production facility to order additional consumable media, such as more labels, tags or the like. As shown, preferably after the order is transmitted by printer 30 and received by web server 68, and the production order for the labels, for example, is transmitted over communication means 72 to a label production machine 74. The labels are then manufactured by the label production machine 74 and transported to shipping dock 76. A courier 78 then picks up the labels manufactured by label production plant 70, and they are subsequently transported to dock 79 of the manufacturing plant 71, and thereafter directly to the printer 30.

FIG. 7 depicts the situation where the manufacturing plant 71 manufactures goods for sale, such as IC chips 80 that need to be labeled, and the printer 30 is programmed to label the IC chips 80 as they are manufactured in manufacturing area 82. Preferably, printer 30 is programmed with the quantity of labels 60 (see FIG. 6) it should order every time it orders labels from website 48, the label part number 62, and the shipping address 64 of manufacturing plant 71. Printer 30 is preferably also programmed with the quantity of labels it must consume before it places a new order from web site 48. As described above, the printer 30 may be programmed with the quantity of labels it must consume over a communications network 44 (i.e., via TCP, UDP, E-Mail, FTP, the printer's serial or parallel port 43) or through the printer's operation panel 35.

After the pre-programmed quantity of labels is printed on printer 30, printer 30 connects to web site 48 and places a new order for labels. The labels are manufactured in facility 70, and delivered by courier 78 to the shipping dock 79 in plant 71, described above, and installed in printer 30 for its consumption.

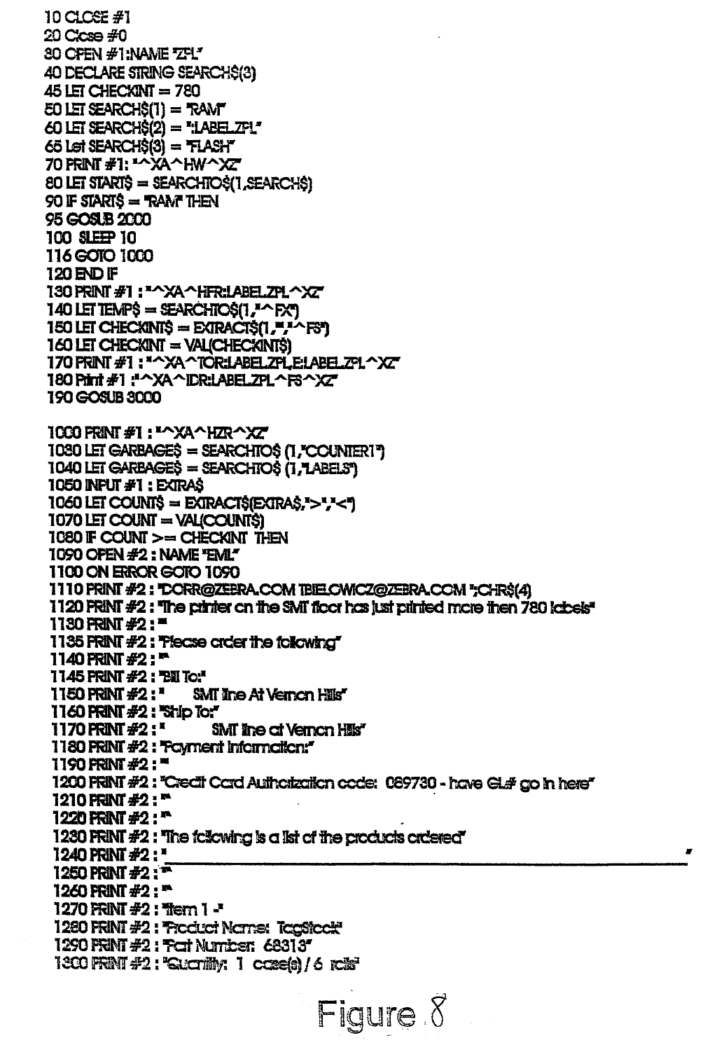

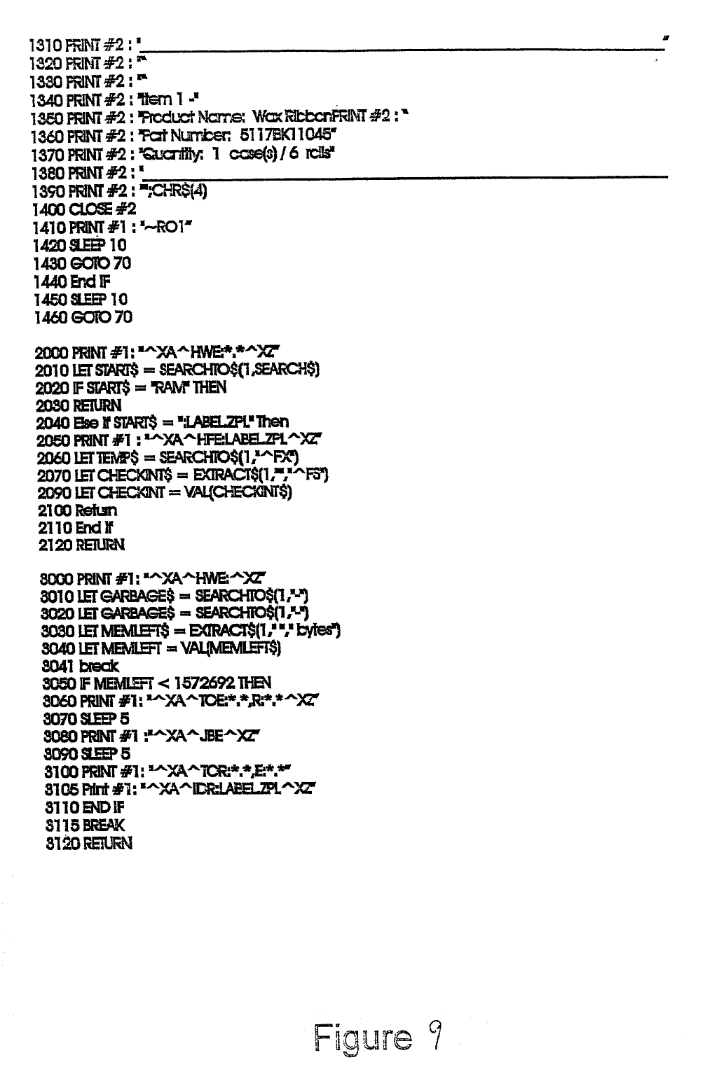

Printer 30 may include firmware (identified as “ZBJ”) which allows custom programs to be written and embedded inside the printer 30 to control its operation. ZBI is part of the operating system of Zebra brand printers under the brand name of ZebraLink, and is well known and understood in the art. A ZBI program which can be used in association with the present invention is shown in FIGS. 8 and 9. As shown, the program can be configured to receive an e-mail message containing information regarding how often the printer 30 should re-order labels, tags or the like. The ZBI program contains information regarding label part numbers, quantity and shipping information, and that information is automatically e-mailed via an e-mail message 50 to a remote destination 42, such as to a consumable media order-fulfillment house or production facility, over a network connection 44, as shown in FIGS. 3 and 5. As shown in FIG. 7, if the destination is a production facility, the production facility receives the e-mail message 50 from the network 44, and responds by producing labels, tags or the like and shipping them to printer 30. After the predetermined number of labels is printed and an order is placed as just described, the printer 30 resets its counting cycle and counts another pre-determined quantity of labels. When the pre-determined quantity of labels have been consumed by the printer 30, printer 30 resets its counting cycle again. The cycle continues automatically ordering new labels after the predetermined quantity of labels have printed until terminated by a user or a new e-mail message is received by the printer 30 which changes the pre-determined label count to another value.

While embodiments of the present invention are shown and described, it is envisioned that those skilled in the art may devise various modifications without departing from the spirit and scope of the foregoing description.

We claim:

1. A printer which is configured to print indicia on consumable media and automatically reorder its own consumable media, said printer comprising: a consumable media measuring apparatus which is configured to measure a quantity of consumable media consumed by said printer; and communications apparatus coupled to the consumable media measuring apparatus, wherein said consumable media measuring apparatus is configured to communicate consumable media consumption data to said communications apparatus and said communications apparatus is configured to transmit the consumable media consumption data to a destination which is external to said printer.

2. A printer as recited in claim 1, wherein said communications apparatus is configured to transmit the consumable media consumption data over a communications network.

3. A printer as recited in claim 1, wherein said communications apparatus is configured to transmit the consumable media consumption data to at least one of a TCP/IP address, UDP/IP address, FTP address, HTTP address and E-Mail address.

4. A printer as recited in claim 1, wherein the communications apparatus is configured to transmit consumable media consumption data to the destination once a pre-determined quantity of consumable media has been consumed by the printer.

5. A printer as recited in claim 4, wherein the printer is configured such that the pre-determined quantity of consumable media is receivable by the printer over a communications network.

6. A printer as recited in claim 5, wherein the printer is configured such that the pre-determined quantity of consumable media is receivable by the printer under at least one of TCP/IP, UDP/IP, HTTP, E-Mail, serial port communications and parallel port communications.

7. A printer as recited in claim 5, further comprising an operations panel, wherein the pre-determined quantity of consumable media is receivable by the printer via the operations panel.

8. A printer as recited in claim 1, wherein the printer is configured to order consumable media.

9. A printer as recited in claim 8, wherein the printer is configured to fill in a web page, thereby ordering the consumable media.

10. A printer which is configured to print indicia on consumable media and automatically reorder its own consumable media, said printer comprising: means for measuring a quantity of consumable media consumed by the printer; means for generating a consumable media consumption value; and means for communicating the consumable media consumption value to a destination external to said printer.

11. A method for a printer to automatically reorder its own consumable media comprising: measuring the quantity of consumable media consumed by the printer; creating a media consumption value based on the quantity of consumable media measured; and communicating the consumable media consumption value to a destination external to the printer.

12. A method as recited in claim 11, further comprising transmitting the consumable media consumption data over a communications network.

13. A method as recited in claim 11, further comprising transmitting the consumable media consumption data to at least one of a TCP/IP address, UDP/IP address, FTP address, HTTP address and E-Mail address.

14. A method as recited in claim 11, further comprising transmitting the consumable media consumption data to the destination once a pre-determined quantity of consumable media has been consumed by the printer.

15. A method as recited in claim 14, further comprising receiving the pre-determined quantity of consumable media over a communications network.

16. A method as recited in claim 15, further comprising receiving the pre-determined quantity of consumable media printer under at least one of TCP/IP, UDP/IP, HTTP, E-Mail, serial port communications and parallel port communications.

17. A method as recited in claim 15, further comprising receiving the pre-determined quantity of consumable media via an operations panel on the printer.

18. A method as recited in claim 11, further comprising ordering consumable media.

19. A method as recited in claim 11, further comprising filling in a web page, thereby ordering the consumable media.

20. A computer readable medium having stored thereon computer executable instructions readable by a printer, including instructions configured to direct the printer to measure a quantity of consumable media consumed by the printer, instructions configured to direct the printer to create a media consumption value based on the quantity of consumable media measured; and instructions configured to direct the printer to communicate the consumable media consumption value to a destination external to the printer.

21. A method of keeping a printer supplied with consumable media, said method comprising: having the printer monitor the quantity of consumable media consumed by the printer; having the printer order consumable media from a order-fulfillment house; and receiving fresh consumable media from the order-fulfillment house.

22. A method as recited in claim 21, wherein the step of having the printer order consumable media from the order-fulfillment house comprises having the printer fill in a web page.
